(19) United States
(12) Patent Application Publication
(10) Pub. No.: US 2009/0252400 A1
(43) Pub. Date: Oct. 8, 2009

(54) METHOD FOR MOUNTING ELECTRONIC COMPONENT

(75) Inventor: Atsushi Iwase, Tokyo (JP)

Correspondence Address: DRINKER BIDDLE & REATH (DC), 1500 K STREET, N.W., SUITE 1100, WASHINGTON, DC, 20005-1209, US

(73) Assignee: JUKI CORPORATION, Chofu-shi (JP)

(21) Appl. No.: 12/414,207

(22) Filed: Mar. 30, 2009

(30) Foreign Application Priority Data
Mar. 31, 2008 (JP) P2008-093044
Mar. 27, 2009 (JP) 2009-078244

(51) Int. Cl. G06K 9/00; H04N 7/18

(52) U.S. Cl. 382/141; 348/E07.085; 348/87

(57) ABSTRACT

In order to recognize grid-like reference marks on a jig plate positioned in a mounting area by means of a substrate recognizing camera respectively, to obtain a positional shift amount of a mounting head with respect to XY coordinates on an apparatus of each of the reference marks, and to correct a mounting position, thereby carrying out a mounting operation, a jig component positioned and mounted sequentially on each of the reference marks formed on the jig plate by means of a nozzle head is recognized by the substrate recognizing camera, a shift amount of XY coordinates acquired by the camera recognition of the jig component from XY coordinates on the apparatus of the corresponding reference mark is obtained as corrected data on the nozzle head with respect to the reference mark, and a correction is carried out based on the corrected data when an electronic component is to be mounted on a substrate by means of the nozzle head.

### FIELD OF THE INVENTION

The present invention relates to a method of mounting an electronic component in a target position on a substrate with high precision.

### DESCRIPTION OF RELATED ART

In an electronic component mounting apparatus, a mounting head picking up an electronic component from a component supplying portion is moved onto a substrate positioned in a mounting area to carry out mounting. A position in which the component is to be actually mounted does not always have a relative positional relationship which is set onto control data and a positional shift is caused by various factors.

The positional shift of the mounting component is caused by a mechanism error and is not always uniform, and a specific positional shift amount is obtained in each position in a mounting area for positioning the substrate.

An example of the factors will be described with reference to FIG. 1. An electronic component mounting apparatus usually includes an X shaft 2 for moving a mounting head 1 in an X direction, left and right Y shafts 3 for moving the mounting head 1 integrally with the X shaft 2 in a Y direction, a substrate recognizing camera 4 for recognizing a substrate mark annexed to the mounting head 1, and a rail 5 for delivering a substrate S to be a mounting target and placing the substrate S in a threshold position in a mounting area. FIG. 1 shows a positional relationship between the respective portions.

FIG. 1A shows the case in which bending is generated on the X shaft 2 itself which also functions as a guide for moving the mounting head 1. FIG. 1B shows the case in which a parallel relationship between the rail 5 for delivering substrate S and the X shaft 2 is lost. FIG. 1C shows the case in which an orthogonal relationship between the X axis 2 and the Y axis 3 is lost.

An overlap of these factors causes a positional shift amount which is varied depending on a moving position of the mounting head 1.

Means for acquiring a specific positional shift amount which is generated in each position in the mounting area has been disclosed in Patent Document 1, for example. The means is a method using a jig plate P for measuring a positional shift in which a reference mark M is arranged and formed like a grid. The jig plate P is fabricated to have a dimension and a shape according to a basis in such a manner that a positioning error is not made, and the grid-like reference mark M corresponding to XY coordinates in an apparatus (a design) is provided on a surface of the plate P with predetermined precision as shown in an image of FIG. 2.

The jig plate P is positioned in the mounting area in the same manner as the substrate S mounting an electronic component thereon and the substrate recognizing camera 4 is XY moved together with the mounting head 1 as shown in FIG. 3, and at the same time, an image of the jig plate P is picked up and the grid-like reference mark M corresponding to the XY coordinates in an apparatus (a design) is subjected to an image recognition. Consequently, a positional shift amount caused by a mechanism error in each position in the mounting area is acquired and used as corrected data in the mounting operation.

When the electronic component is to be actually mounted, moving coordinates of the mounting head which are intended are corrected based on the positional shift amount acquired as the corrected data from a reference mark in the vicinity of a moving destination before the moving coordinates are determined. Consequently, it is possible to mount the electronic component in each position in the mounting area with high precision without a variation.

[Patent Document 1] Japanese Patent No. 3697948 Publication

Referring to the conventional method using the jig plate, however, there is detected the positional shift amount of the substrate recognizing camera 4, that is, the mounting head in the mounting area. In some cases, the positional shift amount is different from a positional shift amount in the mounting position for the electronic component through an adsorbing nozzle 7. The reason will be described with reference to FIG. 3.

In some cases in which a plurality of nozzle heads 7 having the adsorbing nozzles 6 attached thereto is mounted on the mounting head 1 (the single nozzle head 7 is typically illustrated in FIG. 3), a center of a shaft of the nozzle head 7 is eccentric to an optical axis of the substrate recognizing camera 4 as shown in an arrow. An amount of the eccentricity is varied depending on the respective nozzle heads 7. If a difference between a height of the substrate recognizing camera 4 (the mounting head) and a height of an upper surface of the substrate S is increased more greatly, furthermore, a deviation is made greater.

As a result, it is impossible to accurately correct a positional shift when mounting the electronic component through a simple correction based on a result obtained by recognizing the reference mark as in the conventional method.

### SUMMARY OF INVENTION

It is an object of the invention to always mount an electronic component in a target position with high precision also in the case in which a shaft center of the nozzle head mounted on the mounting head 1 is eccentric.

In order to attain the object, the invention provides a method of mounting an electronic component which positions a jig plate having a grid-like reference mark formed thereon in a mounting area for positioning a substrate to mount an electronic component thereon, then picks up and recognizes an image of the grid-like reference mark integrally with a mounting head by means of a substrate recognizing camera to be XY moved, obtains a positional shift amount of the mounting head for XY coordinates on an apparatus which correspond to the reference mark from a shift amount of XY coordinates acquired by the camera recognition of each reference mark from the XY coordinates on the apparatus, and corrects a mounting position based on the positional shift amount and mounts the electronic component on the substrate positioned in the mounting area by means of a nozzle head mounted on the mounting head, including the steps of holding a jig component for correcting by means of the nozzle head and then positioning and mounting the jig component sequentially on the reference mark formed on the jig plate while carrying out a correction based on the positional shift amount, picking up and recognizing an image of the mounted jig component by means of the substrate recognizing camera, and obtaining a shift amount of XY coordinates acquired by the camera recognition of the jig component from XY coordinates on the apparatus of the corresponding reference mark as corrected data of the nozzle head for the reference mark, and correcting the XY coordinates on the apparatus corresponding to the reference mark based on the corrected data when mounting the electronic component on the substrate by means of the nozzle head.

In the invention, a correction amount in an X direction with respect to a target mounting position on the apparatus is obtained through an interpolation from corrected data corresponding to two reference marks which are immediately close to each other and interpose the mounting position therebetween in the X direction respectively, and a correction amount in a Y direction is obtained through an interpolation from corrected data corresponding to two reference marks which are immediately close to each other and interpose the mounting position therebetween in the Y direction respectively.

Moreover, it is also possible to previously create the corrected data on the nozzle head at two different temperatures or more, and to use corrected data created through an interpolation from the corrected data corresponding to the reference mark acquired at the two temperatures interposing a current temperature therebetween before obtaining a correction amount for the mounting position.

### BRIEF DESCRIPTION OF THE DRAWINGS

FIG. 1 is an explanatory view illustrating a factor of a positional shift which is caused on a mounting head according to the conventional art,

FIG. 2 is a plan view showing an image of a jig plate to be used for correcting a position of a mounting head according to the prior art,

FIG. 3 is an explanatory view showing a factor of a positional shift other than the mounting head which is caused on a mounting component according to the prior art,

FIG. 4 is a perspective view showing a whole electronic component mounting apparatus to be applied to a first embodiment, a part of which is taken away,

FIG. 5 is a plan view showing an image of a jig component to be used for correcting a position of a nozzle head,

FIG. 6 is a flowchart showing a procedure for creating corrected data according to the embodiment,

FIG. 7 is an explanatory view showing a method of calculating corrected data for each reference mark,

FIG. 8 is a table showing an image of an example of the corrected data created according to the embodiment,

FIG. 9 is an explanatory diagram showing an example of a calculation for correcting a mounting position through the corrected data which are created, and

FIG. 10 is an explanatory diagram showing a correcting method according to a second embodiment.

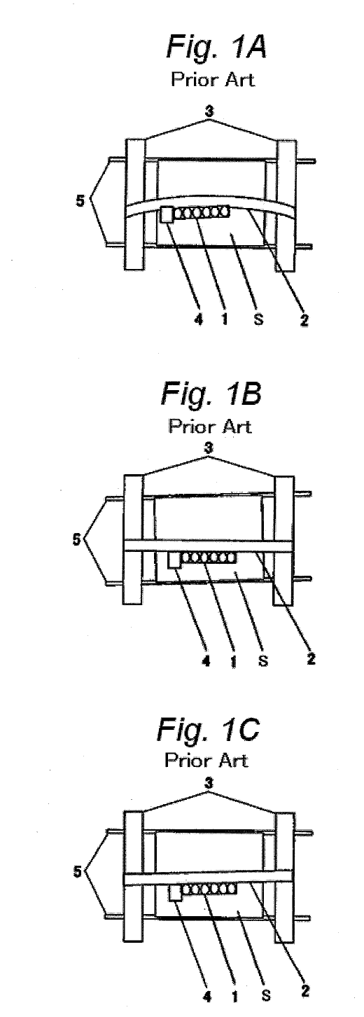

### BEST MODE FOR CARRYING OUT THE INVENTION

An embodiment according to the invention will be described below in detail with reference to the drawings.

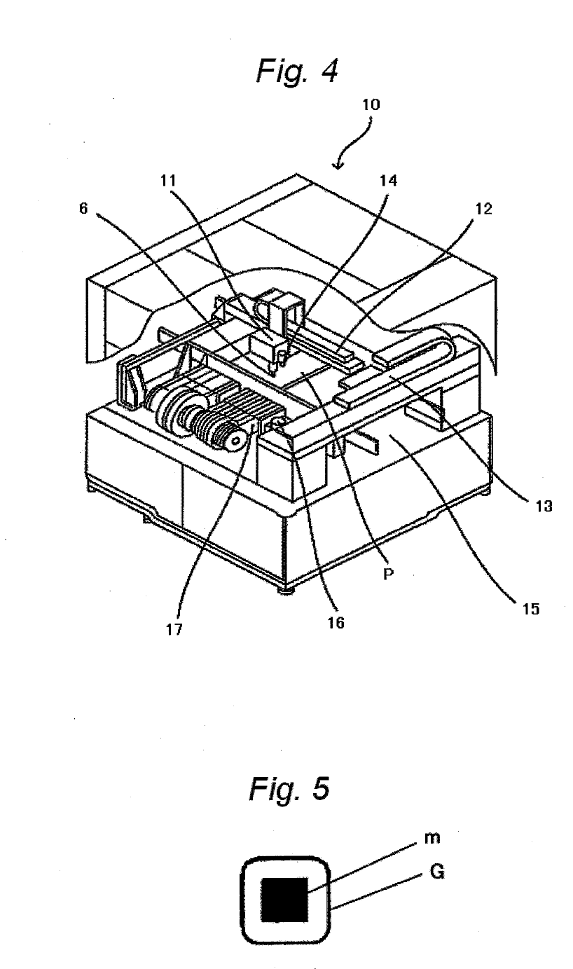

FIG. 4 is a schematic view showing an electronic component mounting apparatus to be applied to a first embodiment according to the invention, a part of which is taken away.

In a mounting apparatus 10, a mounting head 11 is movable in X and Y directions through an X shaft 12 and a Y shaft 13, and the same nozzle heads as those shown in FIG. 3 are mounted on the mounting head 11 (which are not clearly shown in FIG. 4). For convenience, the same reference numerals as those in FIG. 3 are used. An adsorbing nozzle 6 for adsorbing an electronic component is attached to a tip of a shaft of each nozzle head 7 and moving and positioning operations in vertical and rotating directions can be carried out.

A substrate recognizing camera 14 for recognizing a reference mark on a substrate and a mounted component is attached to the mounting head 11 and can carry out an XY movement integrally with the mounting head 11. Moreover, there are disposed a substrate delivering portion 15 for delivering a circuit board onto a base and positioning the circuit board in a mounting area to be a clamp portion, a component recognizing camera 16 for recognizing a component with higher precision, and a component supplying portion 17 for supplying the component to a pickup position.

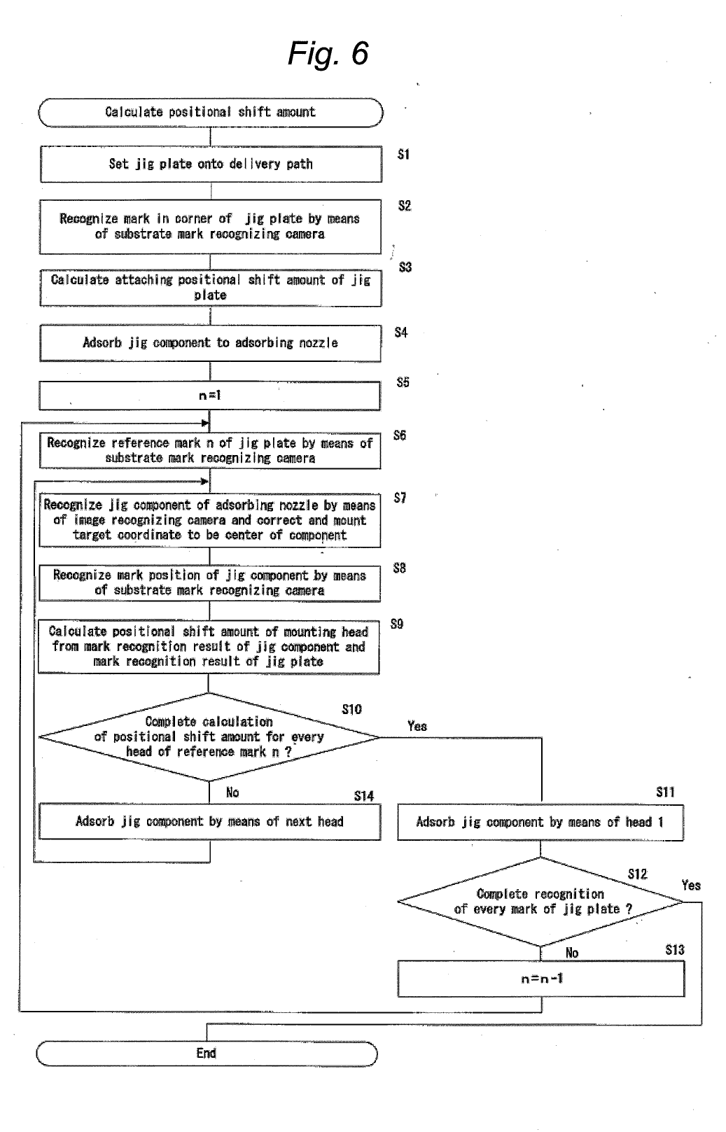

In the embodiment, data corrected through the nozzle head to be used are created every grid-like reference mark M of the jig plate P in accordance with a flowchart shown in FIG. 6.

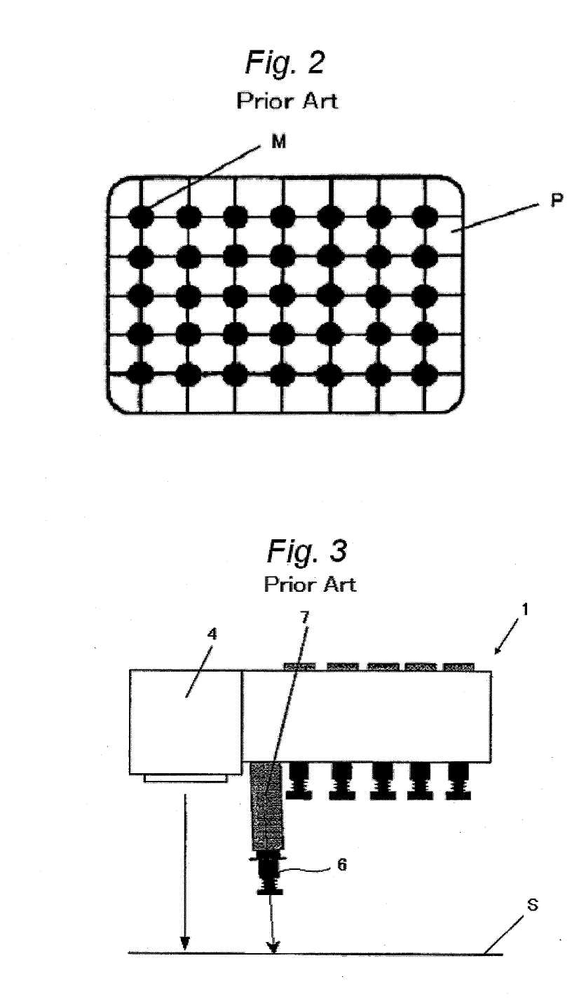

First of all, in the mounting apparatus shown in FIG. 4, the jig plate P having the reference mark M formed like a grid as shown in FIG. 2 is positioned and set into the mounting area of the substrate delivery path 15 in the same manner as in a substrate for mounting an electronic component thereon (Step 1).

Next, the reference mark provided in a corner (a corner portion) on the jig plate P is recognized to calculate an attaching shift amount in the mounting area of the jig plate P itself and to define a position of each reference mark M by XY coordinates on the apparatus (Steps 2 and 3).

Subsequently, a jig component G is adsorbed by means of the adsorbing nozzle 6 of the single nozzle head 7 (Step 4). The jig component G is a correcting jig created, with high precision, by a transparent material such as silicon or glass on which a central mark m of a square is formed around a center of an almost square as shown in an image seen from above in FIG. 5, and can be adsorbed and held in the same manner as the electronic component, and furthermore, can recognize the central mark m by means of the camera from both a surface and a back face.

Then, the substrate recognizing camera 14 is moved to coordinates of an n-th (n=1 at first) reference mark (hereinafter referred to as a reference mark n) on the jig plate P which is positioned while an attaching shift amount of the jig plate P calculated by a mark recognition is corrected. Thus, a reference mark 1 indicated as M1 in the drawing is recognized (Steps 5 and 6).

Thereafter, the jig component G adsorbed by the adsorbing nozzle 6 is subjected to an image recognition by using the component recognizing camera 16 shown in FIG. 4. If there is an adsorbing shift as a result of the recognition, a correction is carried out to mount the jig component G onto a central position of the grid-like reference mark 1 in such a manner that a center thereof is coincident therewith (Step 7). Subsequently, the substrate recognizing camera 14 is moved to the position of the reference mark 1 again to recognize a position of the mark m of the jig component G which has just been mounted (Step 8).

By subtracting a result of the recognition for the mark M of the jig plate P from that of the recognition for the mark m of the jig component G, it is possible to calculate a positional shift amount for the reference mark 1 of the nozzle head 7 mounted on the mounting head 11 (Step 9). The operations of the Steps 6 to 9 are executed for all of the reference marks M (Steps 10 to 13).

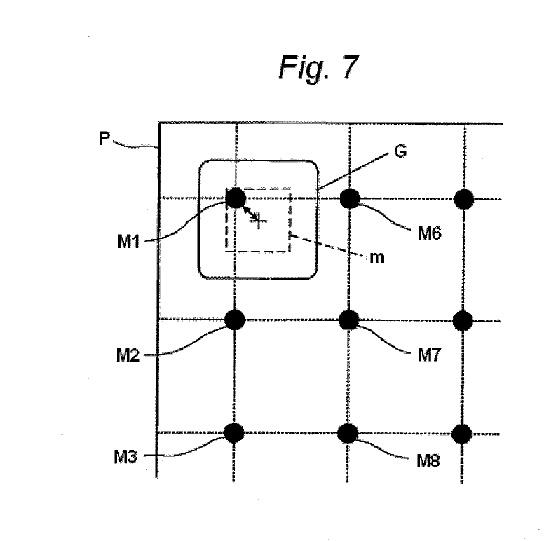

An image of the method of calculating the positional shift amount for the reference mark 1 will be described with reference to FIG. 7 in which a left and upper part of the jig plate P is enlarged.

By the following equation, there is obtained an amount of a positional shift caused by an eccentricity in the case in which the jig component G adsorbed by any of the nozzle heads 7 is positioned and mounted on the reference mark 1 indicated as M1 by the method described above.

Positional shift amount of nozzle head=Result of mark recognition of jig component (central coordinate of mark m)−Result of mark recognition of jig plate (central coordinate of mark M1)

More specifically, in a conventional method of carrying out a correction by recognizing the reference mark M on the jig plate P by means of the substrate recognizing camera 14 provided on the mounting head 11, a positional shift is caused by the nozzle head used every reference mark M.

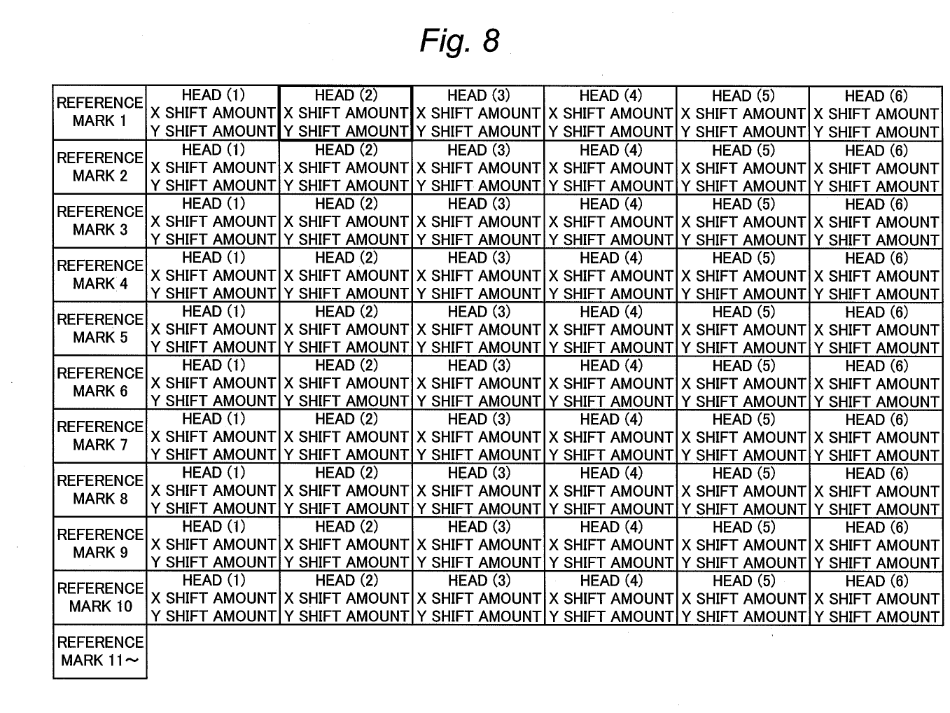

In the embodiment, therefore, the operations of the Steps 6 to 9 are executed for all of the grid-like reference marks M in the jig plate P (Steps 10 to 13), and furthermore, the operations of the Steps 6 to 13 are executed for all of six nozzle heads 7 mounted on the mounting head 11 (Step 14) and a positional shift amount table (corrected data) for each reference mark M is created for each of the nozzle heads indicated as heads (1) to (6) in FIG. 8. Consequently, it is possible to correspond to the correction of each of the nozzle heads and each of the reference marks.

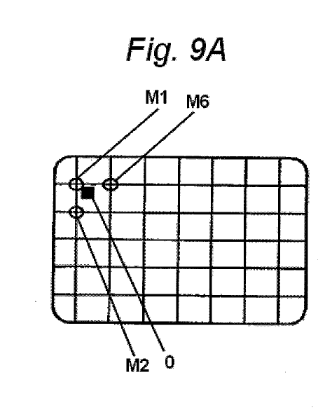

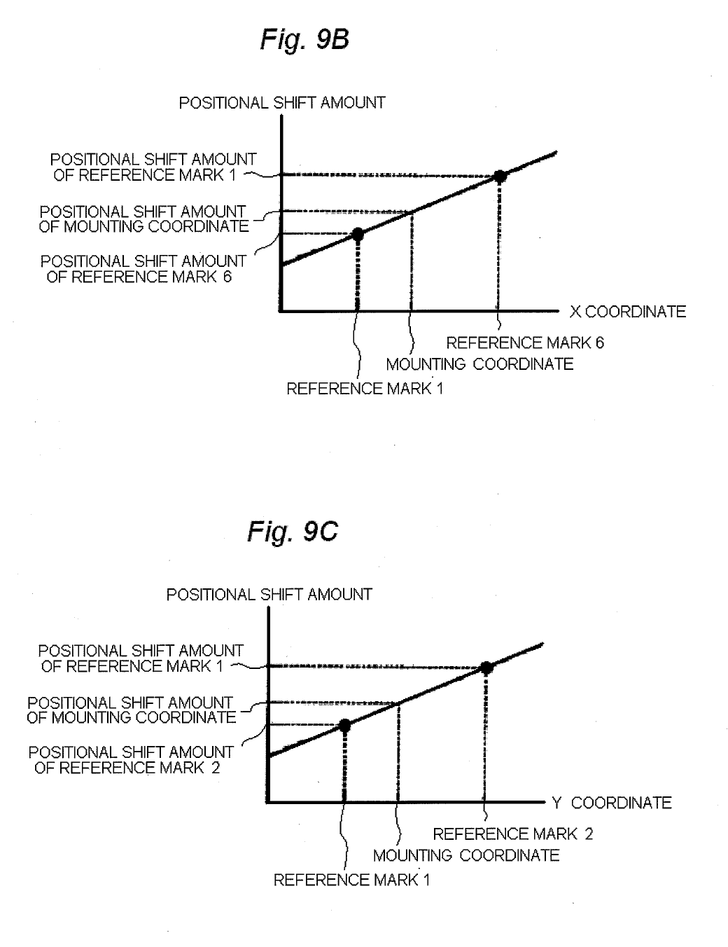

As described above in detail, it is possible to accurately correct a position onto target XY moving coordinates when mounting an electronic component by using the positional shift amount table for each reference mark M. A specific correcting method will be described with reference to FIG. 9.

With reference to FIG. 9A, there will be supposed the case in which an electronic component is mounted by using a head (1) in a target mounting position indicated as O in FIG. 9A which is close to adjacent reference marks 1, 2 and 6 indicated as M1, M2 and M6 in the same manner as in FIG. 7, for example. In this case, reference is made to corrected data on the reference marks 1, 2 and 6 which are immediately close to the mounting position O.

First of all, for an X coordinate of the mounting position O, the positional shift amounts of the two reference marks 1 and 6 which interpose the mounting position O therebetween and are immediately close to each other are retrieved from a table shown in FIG. 8 for the head (1), and a linear interpolation is carried out based on the X coordinate of the mounting position O from data (shift amounts in an X direction) on two corresponding points as shown in FIG. 9B. Thus, a positional shift amount in the X direction is obtained.

Based on a relationship of the mounting position O, next, the reference marks for the two points which interpose the mounting position O therebetween and are immediately close to each other are retrieved to enclose a Y coordinate of the electronic component mounting apparatus in a close column in the X direction, that is, for the Y coordinate of the mounting position O. The linear interpolation is carried out based on the Y coordinate of the mounting position O and the data on the two points (M1, M6) through data (shift amounts in a Y direction) on the two points (M1, M2) of the corresponding reference marks 1 and 2. Thus, the positional shift amount in the Y direction is obtained.

According to the embodiment described above in detail, by correcting the moving coordinates from the data on the positional shift amount in the vicinity of a moving destination before determining, the moving coordinates of the nozzle head for adsorbing the component in order to mount the electronic component into the target mounting position based on the positional shift amount table created for each of the nozzle heads and each of the reference marks M, it is possible to carry out the mounting operation with high precision without a variation in each mounting position.

Next, description will be given to a second embodiment according to the invention.

In the embodiment, the positional shift amount (corrected data) for each of the reference marks M in each of the nozzle heads described in the first embodiment is acquired at two different temperatures or more to correct a mechanism displacement with a change in the temperature in the mounting operation and to further enhance precision.

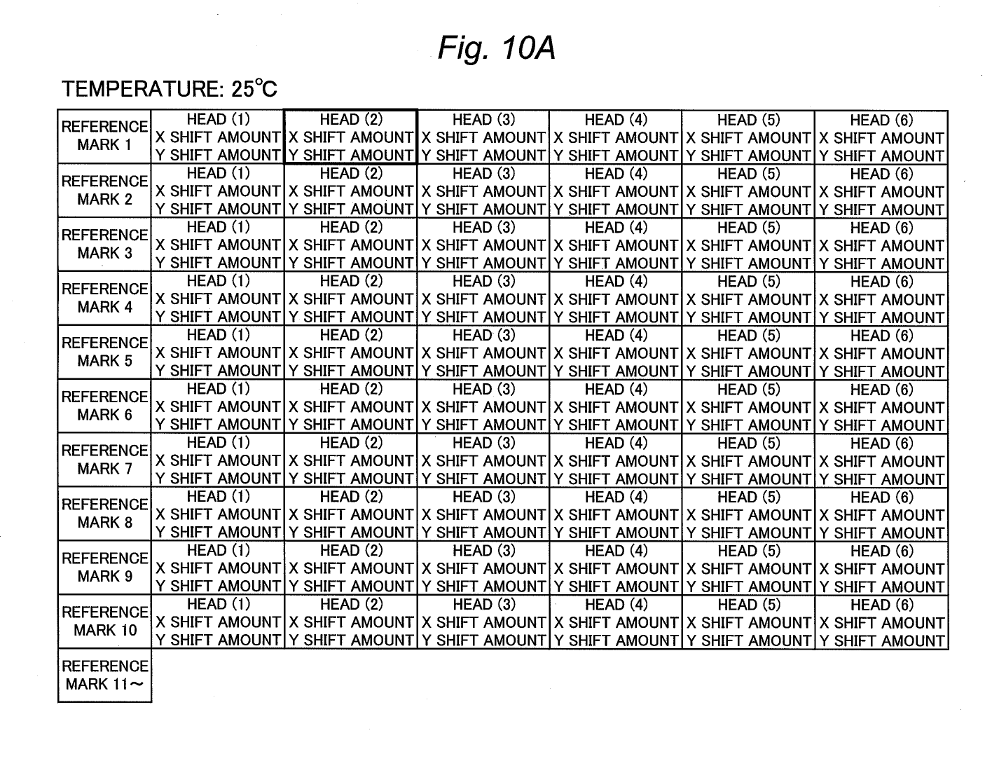

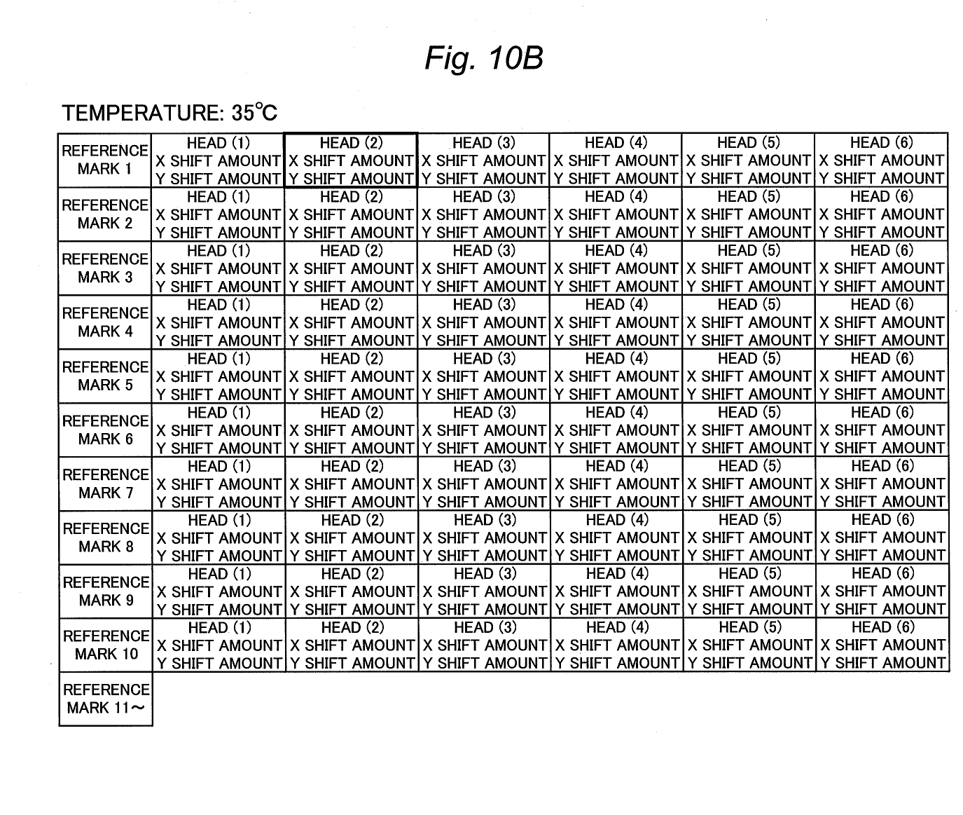

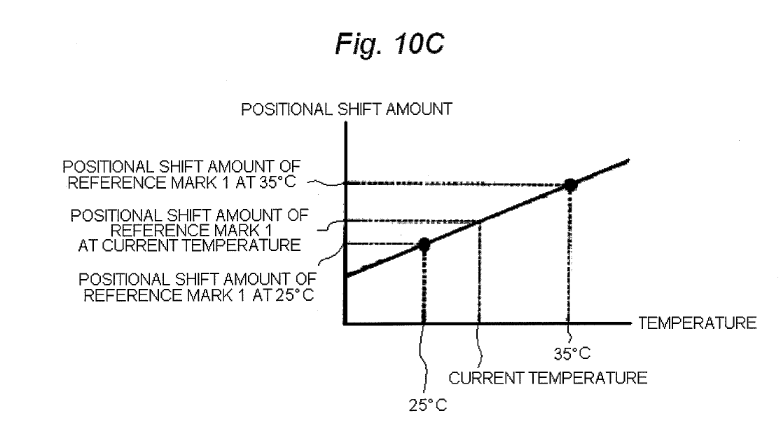

In FIGS. 10A and 10B, a positional shift amount table (corrected data) shown in FIG. 8 is created to typically indicate data on a head (1) for a reference mark 1 at 25° C. and 35° C. as an example which are enclosed with a thick line.

In the same manner as in FIG. 9A, in the case in which an electronic component is mounted at a current temperature between 25° C. and 35° C. in a mounting position to which reference marks 1, 2 and 6 are immediately close as shown in FIG. 10C, a positional shift amount at the current temperature is interpolated and created from positional shift amounts in FIGS. 10A and 10B for the reference marks 1, 2 and 6 and the interpolated data are used to carry out the correcting and mounting operations in the same manner as in the first embodiment.

According to the embodiment, by holding positional shift amount tables created for the respective nozzle heads and the respective reference marks at different temperatures, it is possible to mount an electronic component with high precision also in the case in which a mechanism is displaced with a change in the temperature.
claim 1: A method of mounting an electronic component which positions a jig plate having a grid-like reference mark formed thereon in a mounting area for positioning a substrate to mount an electronic component thereon, then images and recognizes the grid-like reference mark integrally with a mounting head by means of a substrate recognizing camera to be XY moved, obtains a positional shift amount of the mounting head for XY coordinates on an apparatus which correspond to the reference mark from a shift amount of XY coordinates acquired by the camera recognition of each reference mark from the XY coordinates on the apparatus, and corrects a mounting position based on the positional shift amount and mounts the electronic component on the substrate positioned in the mounting area by means of a nozzle head mounted on the mounting head, comprising the steps of:
preparing a jig component for correcting;
holding the jig component by means of the nozzle head and then positioning and mounting the jig component sequentially on the reference mark formed on the jig plate while carrying out a correction based on the positional shift amount;
imaging and recognizing the mounted jig component by means of the substrate recognizing camera, and obtaining a shift amount of XY coordinates acquired by the camera recognition of the jig component from XY coordinates on the apparatus of the corresponding reference mark as corrected data of the nozzle head for the reference mark; and
correcting the XY coordinates on the apparatus corresponding to the reference mark based on the corrected data when mounting the electronic component on the substrate by means of the nozzle head.

2. The method of mounting an electronic component according to claim 1, further comprising the steps of:
obtaining a correction amount in an X direction with respect to a target mounting position on the apparatus through an interpolation from corrected data corresponding to two reference marks interposing the mounting position therebetween in the X direction respectively; and
obtaining a correction amount in a Y direction through an interpolation from corrected data corresponding to two reference marks interposing the mounting position therebetween in the Y direction respectively.

3. The method of mounting an electronic component according to claim 1, wherein the corrected data on the nozzle head are previously created at two different temperatures or more, and corrected data created through an interpolation from the corrected data at the different temperatures are used when an electronic component is to be mounted at the other temperature.

4. A method of mounting an electronic component, comprising the steps of:
positioning a jig plate having a grid-like reference mark in a mounting area for positioning a substrate to mount an electronic component thereon;
imaging and recognizing the grid-like reference mark by means of a substrate recognizing camera which are integrally with a mounting head, and which moves in an XY direction;
calculating a positional shift amount of the jig plate;
obtaining a position of the reference mark from XY coordinates on an apparatus;
holding a jig component for correcting by means of a nozzle head of a nozzle;
positioning and mounting the jig component sequentially on the reference mark formed on the jig plate while correcting a position of the jig component based on the positional shift amount;
imaging and recognizing the mounted jig component by means of the substrate recognizing camera;
calculating a shift amount of XY coordinates acquired by the camera recognition of the jig component from XY coordinates on the apparatus of the corresponding reference mark as corrected data of the nozzle head for the reference mark; and
correcting the XY coordinates on the apparatus corresponding to the reference mark based on the corrected data when mounting the electronic component on the substrate by means of the nozzle head.
